(19) United States
(12) Patent Application Publication
(10) Pub. No.: US 2002/0162460 A1
(43) Pub. Date: Nov. 7, 2002

(54) Container for food products

(76) Inventor: Sergio Tedeschi, San Lazzaro di Savena (IT)

Correspondence Address: Richard J Minnich, 7th Floor, 1100 Superior Avenue, Cleveland, OH, 44114, US

(21) Appl. No.: 10/111,735

(22) PCT Filed: Sep. 7, 2001
(86) PCT No.: PCT/IB01/01620

(30) Foreign Application Priority Data
Sep. 7, 2000 (IT) BO2000A000519

(51) Int. Cl. A21D 10/02

(52) U.S. Cl. 99/403

(57) ABSTRACT

A container for food products comprises, inside a sealed containment body (1), a first meat-based food product (2) and a second food product (3) constituted by broth aspic deriving from the fist meat-based food product (2) and by a component such as vegetable broth.

### TECHNICAL FIELD

The present invention relates to a container for food products, in particular a container for food products containing a meat-based food product, pre-cooked and combined with a liquid partially produced by the same meat-based food product.

### BACKGROUND ART

Currently, in the foodstuffs industry, the offerings provided in sales centres for meat-based products (such as fowl either whole or in one or more sections that can be obtained from the whole body) provide the product raw, cleaned and ready to be cooked, or already cooked and ready to be eaten.

In order adequately to preserve the product for a long time, which is possible only in the first case mentioned above, the cold technique must be used, i.e. maintaining the raw product at low temperature to maintain its integrity.

This obviously entails high costs both for the necessary structures able to allow a proper preservation, and for transporting the product to the sale centres.

In addition, the types of packages offered to the consumer, in particular for the aforesaid meat-based foods, do not have product characteristics able to meet the needs of a complete meal.

In other words, of the individual packages currently known and marketed, none can be used to obtain two courses and an equivalent caloric contribution able to satisfy a normal nutritional requirement.

### DISCLOSURE OF INVENTION

The aim of the present invention, therefore, is to provide a container for food products containing at least a meat-based food product, with the meat appropriately cleaned as a whole body or in recognisable parts (i.e. not chopped), which can be preserved over time with no need to make use of cold technology.

A further aim is to provide a container for food products able to meet the requirements of a complete meal even Without additional operations after the opening of the container.

The aforementioned aims are achieved with a container for food products comprising, within a hermetically sealed containment body, a first meat-based food product and a second food product constituted by broth aspic, deriving from the first meat-based food product, mixed with a component such as vegetable broth.

### DESCRIPTION OF THE DRAWINGS

The technical characteristics of the invention, according to the aforesaid aims, can clearly be noted from the content of the claims set out below and its advantages shall become more readily apparent in the detailed description that follows, made with reference to the accompanying drawings, which show an embodiment provided purely by way of non limiting example, in which:

FIG. 1 shows a perspective view of a container for food products according to the present invention;

FIG. 2 shows a perspective view of the container for food products of FIG. 1 in an open configuration;

FIG. 3 shows a course dish which can be obtained with the food products included within the container of the previous figures;

FIGS. 4 and 5 show front views, with some parts sectioned off, of another course dish which can be obtained with the container of FIGS. 1 and 2;

FIG. 6 shows a perspective view of two course dishes which can be obtained with the container for food products of FIGS. 1 and 2.

### DETAILED DESCRIPTION OF THE PREFERRED EMBODIMENTS OF THE INVENTION

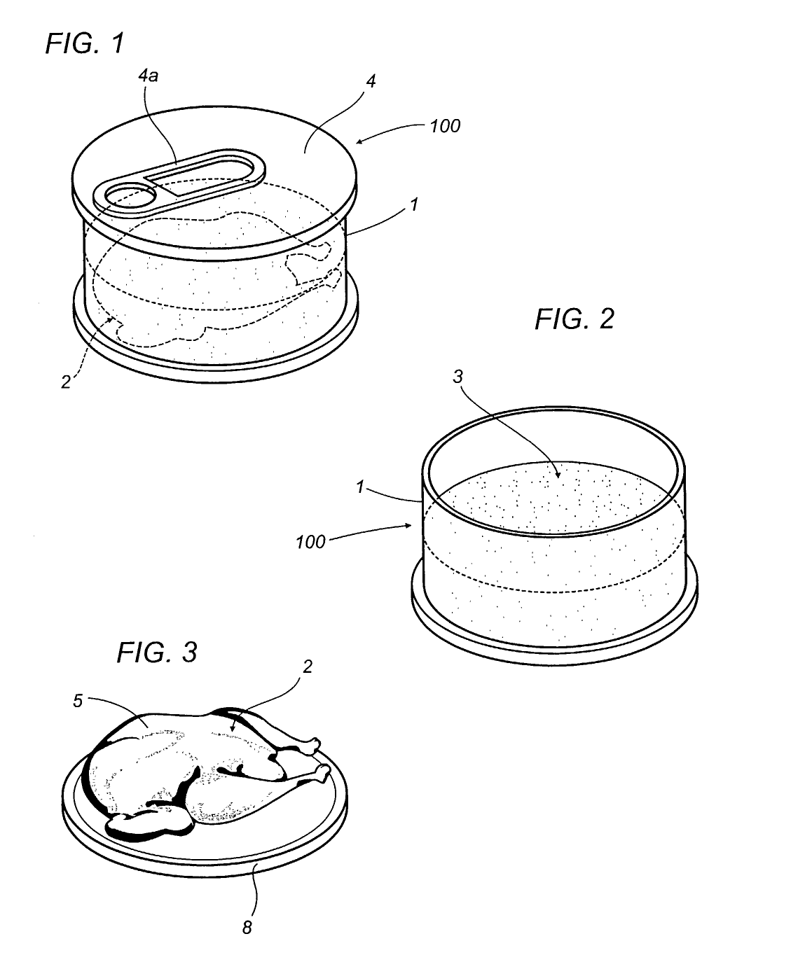

In accordance with the figures of the accompanying drawings, and with particular reference to FIGS. 1 and 2, the container for food products of the present invention, indicated globally with the reference number 100, essentially comprises a hermetically sealed containment body 1 within which is housed a first meat-based food product 2 and a second food product 3 constituted by a broth aspic deriving from the first meat-based food product 2.

In particular, the aforementioned second food product 3 partially derives from the first meat-based food product 2, since the second product 3 can comprise vegetable broth and the broth deriving from the aforementioned first meat-based product 2.

Both the first meat-based food product 2, and the aforesaid vegetable broth are pre-cooked by effect of a sterilisation treatment (as shall be described hereafter).

The aforementioned containment body 1 of the container 100 can, preferably but not exclusively, be opened manually by a traction of a surface 4 defining a lid and provided with an appropriate grip element 4a.

In regard to the aforementioned first meat-based food product 2, it can be constituted, purely by way of non limiting example, of a feathered animal.

In other words, the first food product 2 housed within the containment body 1 can be constituted by a whole hen 5, or by at least a portion or part of the feathered animal: for instance at least a drumstick and thigh of the feathered animal (or multiples thereof), or also a wing and a breast of the feathered animal (or multiples of the same sections of feathered animal).

Purely by way of example, for the achievement of a container for food products as described above, the following phases can be executed:

housing the first meat-based food product 2 (previously cleaned and cut) within said containment body 1;

sealing the containment body 1;

a sterilising treatment followed by pre-cooking of the first product 2 with the formation of a quantity of the second food product 3.

Preferably, after the aforesaid housing of the first meat-based food product 2 in the containment body 1, the insertion of a predefined quantity of vegetable broth is provided, defining a part of the aforesaid second food product 3 together with the broth formed by the first meat-based food product 2 during the sterilisation phase.

By way of example, the heat treatment for sterilisation takes place at a temperature of between 110° and 130° and for a time interval lasting, preferably, between 80 and 100 minutes.

The vegetable broth is inserted in the containment body 1 at a temperature, preferably, between 65° and 70°.

After the sterilisation phase, a controlled cooling of the package is provided, in order to allow the formation of broth aspic constituting the second food product.

Through this solution of container for food products, a sort of pre-packaged and pre-cooked mix is thereby obtained, which leads to the definition of a new food offering for the cannery industry, comprising a container 1 of suitable shape and size, which can contain a meat body 2, normally of a feathered animal, preferably a hen, but without any preclusion against meat from other animals, feathered or not.

Said body 2 can be introduced into the container 1 in whole or sectioned form, also as multiples of predefined sections of the same animal or of several different animals where said units, body or sections, can be introduced free, as they are after being suitably cleaned and cut of possibly wrapped by an appropriate net for compacting the meat, or otherwise in such a way as to maintain said meat body compact even after the subsequent phases of preservation treatment of the container 100 as a whole.

In addition to said meat body 2, a gelatinous liquid or a sort of broth aspic can then be introduced, or another suitable liquid or aspic, normally useful to enhance flavour or taste.

The container 1 thus packaged will be appropriately sealed to be subjected to the aforesaid heat treatment (sterilisation) such as to pre-cook the meat body 2 and allow the internal liquid 3 to be enriched until becoming a veritable broth, absorbing mainly, during this phase, the flavours of the meat body 2, as well as—if present—those of any other additional components.

From the operative point of view, the invention also leads to innovative consequences, such as a solution to save a considerable amount of time for the preparation of dishes which, if separated according to the prior art, would require a great expenditure of time. Moreover, the fact that the two courses in question, based on chicken broth and chicken meat, are part of the traditional cuisine of a multiplicity of countries, makes the product highly useful for the service it renders to the community at large.

Consumption of the packaged foods thus obtained provides for the opening of the lid 4; subsequently, one can:

remove the meat body 2 to complete its preparation according to one of the possible known cooking techniques, for instance heating according to boiling or other criteria, possibly adding ingredients of various kinds to be selected based on local or specific custom and tradition;

pour the broth aspic 3 of the meat body 2 into an appropriate container 9 and proceed, if a dilution is desired, to add as much water as is necessary to reach the required density, then ready its consumption as consommé or with the addition of pasta 11 or other products as preferred and, possibly, heating all on a cooking stove 10.

Thus operating one obtains two courses 7 and 8 whereof one, indicated as 7, is usable as a first course constituted by broth 3 of meat body 2 providing as need be pasta 11 or anything else which may be desired in relation thereto, and a second course 8 constituted by the body 2 itself, with or without the use of side dishes.

The content of the container thus transformed is ready for ready use once the package is opened.

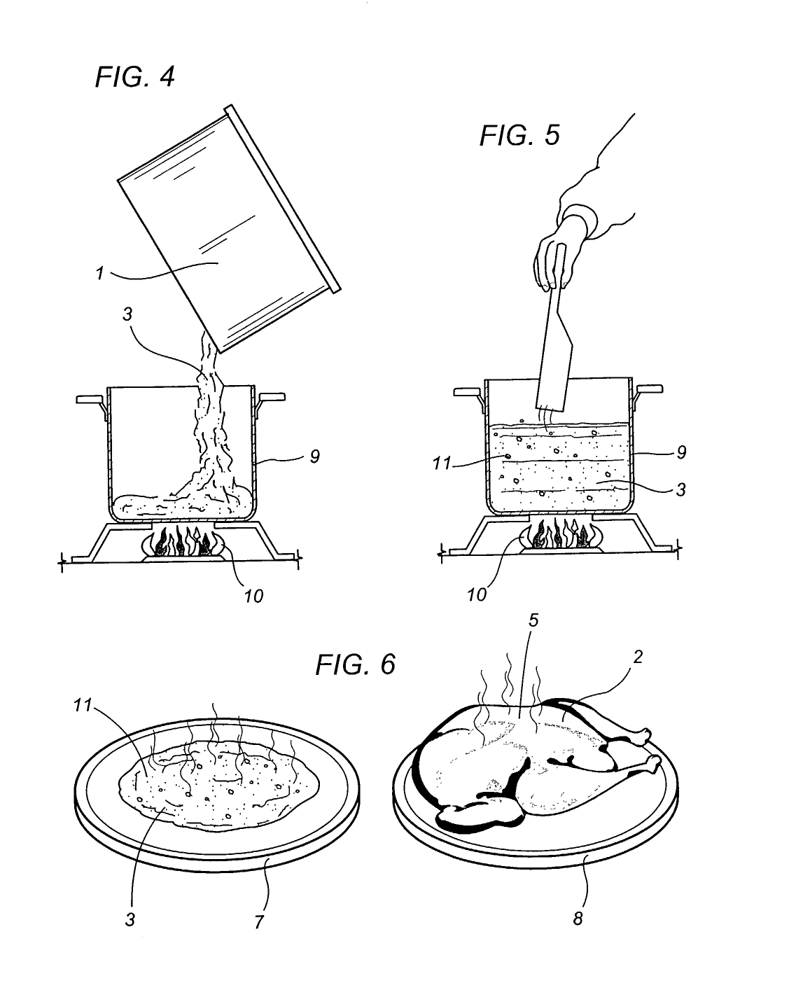

As an example of usage (see FIGS. 3 through 6), the second product 3 or broth obtained can be served as a component of a first course, both using it directly in the concentration level that results spontaneously therefrom, and diluting it, for instance with water, to obtain a consommé or a soup by adding products and/or foods of various kinds.

In regard to the first product or meat body 2, as an additional example, it can instead be used as a main course, serving it as it is after extracting it from the container 1, or adding other foods or products and/or possibly having subjected it to other treatments, or after a combination of such options.

All to meet the requirement to satisfy the food consumption needs of a basic meal.

In so doing, one was able to obtain, starting from an edible but raw component, a pair of singularly appreciable and consumable food products, whose preparation with traditional methods is notoriously long and laborious.

The products thus obtained have also the characteristic of being in a state and in a condition that allows their long-term preservation without being subject to preservation or storage problems.

Another significant peculiarity of the present patent application is that of introducing, in addition to a solution currently unavailable on the market, as amply described above, a technological innovation in the field of food products, linked to the fact that, parting from a single food body, i.e. a fowl body immersed in a liquid or aspic, and subjecting the whole to an appropriate working process, it is possible to obtain two distinct and separable food products.

Moreover, these food products, as previously stated, are also able to provide for meeting the needs of a conventional meal if jointly used, which condition is not met on the market using a single can of preserved food.

The invention thus conceived can be subject to numerous modifications and variations, without thereby departing from the scope of the inventive concept. Moreover, all components can be replaced with technically equivalent elements.

1. Container for food products, characterised in that it comprises within a sealed containment body (1):
a first meat-based food product (2) constituted by a whole body of an animal or at least a recognisable portion or part of such animal, and,
a second food product (3) constituted by broth aspic deriving from said meat-based food product (2).

2. A container as claimed in claim 1, characterised in that said second food product (3) partial derives from said first meat-based food product (2).

3. A container as claimed in claim 1, characterised in that said second product (3) comprises vegetable broth and broth deriving from said fist meat-based product (2).

4. A container as claimed in claim 1, characterised in that said first meat-based food product (2) is pre-cooked.

5. A container as claimed in claims 2 and 3, characterised in that said first meat-based food product (2) and said vegetable broth are pre-cooked.

6. A container as claimed in claim 1, characterised in said containment body (1) can be opened manually by traction of a surface (4) defining a lid.

7. A container as claimed in claim 1, characterised in that said first meat-based food product (2) is consumed by a feathered animal.

8. A container as claimed in claim 7, characterised in that said first meat-based food product (2) is constituted by a whole hen (5).

9. A container as claimed in claim 7, characterised in that said first meat-based food product (2) is constituted by at least a drumstick and thigh of said feathered animal.

10. A container as claimed in claim 7, characterized in that said first meat-based food product (2) is constituted by at least a wing and a breast of said feathered animal.

11. Method for obtaining a container for food products, in particular as claimed in claims 1 through 10, characterised in that it comprises the following phases:
housing said first meat-based food product (2) inside said containment body (1);
sealing said containment body (1);
sterilising and pre-cooking said first product (2) with the formation of a quantity of said second food product (3).

12. Method as claimed in claim 11, characterised in that after housing said first meat-based food product (2) in said containment body (1) a predefined quantity of vegetable broth is inserted, defining a part of said second food product (3) together with the broth formed by said first meat-based food product (2) during said sterilisation phase.

13. Method as claimed in claim 11, characterised in that said sterilisation treatment takes place at a temperate between 110° and 130° and for a time period lasting, preferably, between 80 and 100 minutes.

14. Method as claimed in claim 12, characterised in that said vegetable broth is inserted in said containment body (1) at a temperature between 65° and 70°.

15. Method as claimed in claim 12, characterised in that after said sterilisation phase a phase of controlled cooling of said container is provided, to enable the formation of broth aspic constituting said second food product (3).
